(19) United States
(12) Patent Application Publication
(10) Pub. No.: US 2026/0316529 A1
(43) Pub. Date: Oct. 15, 2026

(54) FILM FOR VEHICLE AND MANUFACTURING METHOD THEROF

(71) Applicant: THINKWARE CORPORATION, Seongnam-si, Gyeonggi-do (KR)

(72) Inventors: Sungcheol Kim, Seongnam-si, Gyeonggi-do (KR); Jinsu Yun, Seongnam-si, Gyeonggi-do (KR)

(73) Assignee: THINKWARE CORPORATION, Seongnam-si, Gyeonggi-do (KR)

(21) Appl. No.: 19/106,708

(22) PCT Filed: Aug. 25, 2023
(86) PCT No.: PCT/KR2023/012671

§ 371 Date: Dec. 8, 2025

(30) Foreign Application Priority Data
Aug. 26, 2022 (KR) 10-2022-0107528
Aug. 24, 2023 (KR) 10-2023-0111598

(51) Int. Cl. B60J 3/00; B60J 3/04; G02F 1/1334; G02F 1/1343

(52) U.S. Cl. CPC B60J 3/002; B60J 3/04; G02F 1/1334; G02F 1/13439

(57) ABSTRACT

According to an embodiment, a film for a vehicle includes a liquid crystal layer, a first conductive polymer layer laminated on a first surface of the liquid crystal layer, a second conductive polymer layer laminated on a second surface opposite to the first surface of the liquid crystal layer, a first substrate layer on the first conductive polymer layer, a second substrate layer on the second conductive polymer layer, a first electrode layer between the first conductive polymer layer and the first substrate layer, and a second electrode layer between the second conductive polymer layer and the second substrate layer. The film has a curvature by being at least partially bent.

### TECHNICAL FIELD

Various embodiments to be described later relate to a film for a vehicle and a manufacturing method thereof.

### BACKGROUND ART

A film may be attached to a window of a vehicle to meet a request of a user boarding the vehicle. The film may include a smart film capable of adjusting transparency by a user input. The film may provide the user boarding the vehicle with various user experiences, for example, by being attached to a glass roof on the top of the vehicle. The film may be required to be manufactured to be easily attached to the window of the vehicle by a user.

The above-described information may be provided as a related art for the purpose of helping to understand the present disclosure. No claim or determination is raised as to whether any of the above-described information may be applied as a prior art related to the present disclosure.

### DISCLOSURE

### Technical Solution

According to an embodiment, a film for a vehicle may comprise a liquid crystal layer, a first conductive polymer layer laminated on a first surface of the liquid crystal layer, a second conductive polymer layer laminated on a second surface opposite to the first surface of the liquid crystal layer, a first substrate layer on the first conductive polymer layer, a second substrate layer on the second conductive polymer layer, a first electrode layer between the first conductive polymer layer and the first substrate layer, and a second electrode layer between the second conductive polymer layer and the second substrate layer. The film may have a curvature by being at least partially bent.

According to an embodiment, a manufacturing method of a film for a vehicle may comprise preparing a film fabric, heating the prepared film fabric, vacuum forming the heated film fabric, and cutting the vacuum formed film fabric.

### DESCRIPTION OF THE DRAWINGS

FIG. 1A is a top plan view of an exemplary vehicle.

FIG. 1B illustrates an internal structure of an exemplary vehicle.

FIG. 2 is a flowchart illustrating an exemplary film manufacturing process.

FIG. 3 is a cross-sectional view of an exemplary film.

FIG. 4 illustrates a heating process of an exemplary film.

FIG. 5 illustrates a vacuum forming process of an exemplary film.

FIG. 6 illustrates an exemplary film to which a wire is connected.

FIG. 7 is a flowchart illustrating a process for installing an exemplary film in a vehicle.

FIG. 8 illustrates an internal structure of a vehicle to which an exemplary film is attached.

### MODE FOR INVENTION

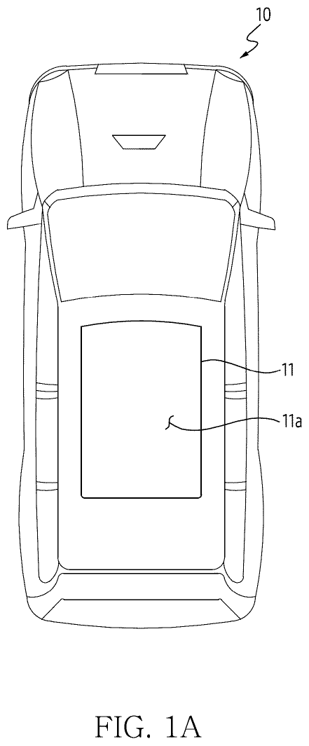

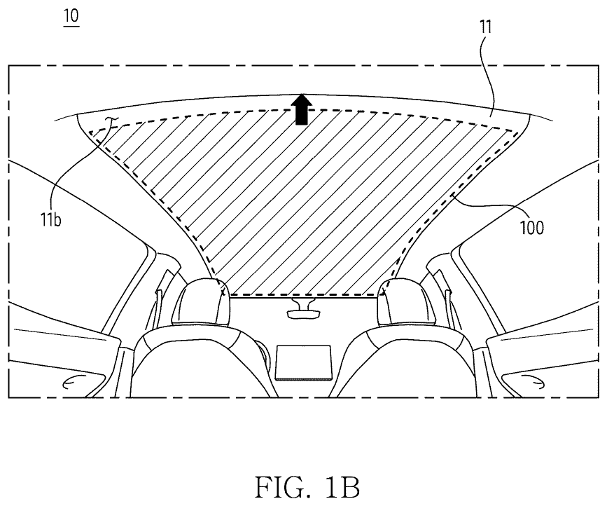

FIG. 1A is a top plan view of an exemplary vehicle. FIG. 1B illustrates an internal structure of an exemplary vehicle.

Referring to FIG. 1A and IB, a vehicle 10 may include a sunroof 11. A film 100 may be attached to the vehicle 10.

According to an embodiment, the sunroof 11 may be disposed on the top of the vehicle. For example, the sunroof 11 may be disposed on the vehicle 10 to be positioned over a user boarding the vehicle. For example, the sunroof 11 may provide visibility of an external environment of the vehicle 10 to the user boarding the vehicle 10, by including a substantially transparent material (e.g., glass). For example, the sunroof 11 that provides visibility of the external environment to the user boarding the vehicle 10 may be referred to as a glass roof, but is not limited thereto. The vehicle 10 may be required to adjust the visibility provided through the sunroof 11 to meet the needs of the user boarding the vehicle 10.

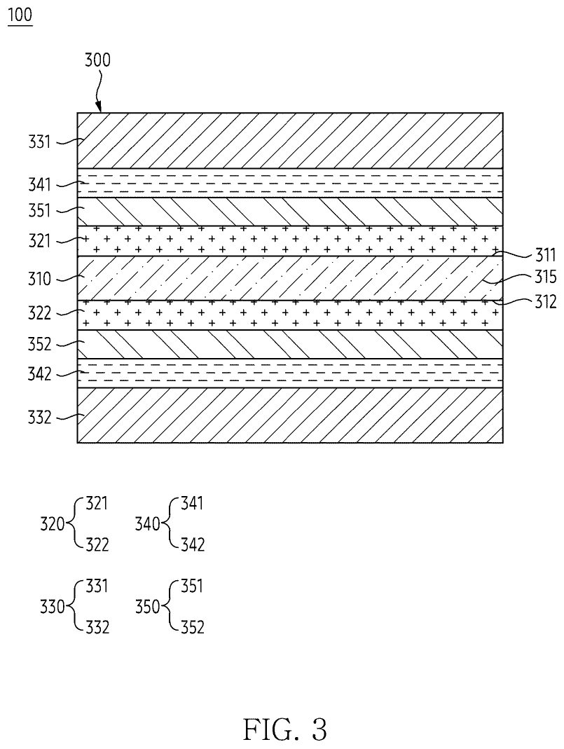

According to an embodiment, the film 100 may be attached to the sunroof 11. The sunroof 11 may include an outer surface Ila facing the outside of the vehicle 10 and an inner surface 1 1b opposite to the outer surface I la and facing the inside of the vehicle 10. The film 100 may be attached onto the inner surface 1 1b among the outer surface 11a and the inner surface 11b of the sunroof 11. For example, the film 100 may include a substantially transparent or translucent material. The film 100 may be configured such that the transparency of the film 100 is adjusted by a user. A change in the transparency of the film 100 will be described later in FIG. 3. For example, the film 100 may be configured to change the transparency of the film 100 according to the intensity of current flowing inside the film 100. The film 100 whose the transparency is changed according to the intensity of the current may be referred to as a smart film or a polymer dispersed liquid crystal (PDLC) film, but is not limited thereto.

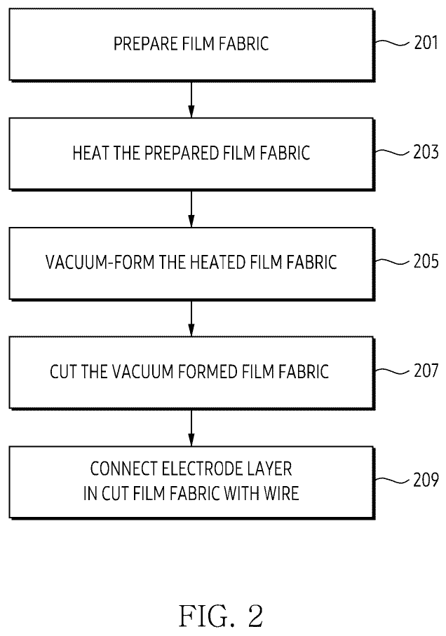

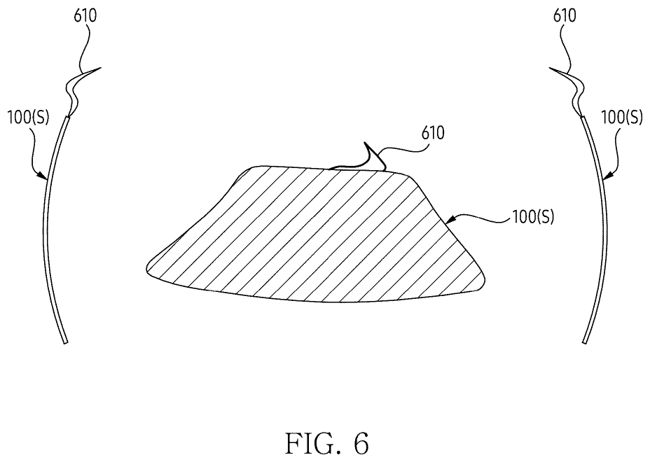

According to an embodiment, the film 100 may be provided in the form of a fabric (e.g., the film fabric 300 of FIG. 3) to be attached to the sunroof 11 of the vehicle 10. In order to be easily attached to the sunroof 11 of the vehicle 10, the film 100 may be required to be processed into a shape corresponding to a shape of the sunroof 11. For example, the film 100 may be required to be cut to a size corresponding to a size of the sunroof 11 of the vehicle 10 after being provided in the form of a fabric. For example, the film 100 may be required to be cut to a size corresponding to the size of the sunroof 11 and then formed into a shape corresponding to the shape of the sunroof 11. For example, after the film 100 is formed into a shape corresponding to the shape of the sunroof 11, a wire (e.g., the wire 610 of FIG. 6) for supplying power to the inside of the film 100 may be required to be connected to the film 100. Since the film 100 is provided in a shape corresponding to each shape of the sunroof 11 that varies according to the vehicle 10, an unnecessary process of processing the film 100 may be omitted. Since the film 100 is provided in a structure in which a wire for supplying power is connected to the inside of the film 100, a process of installing the film 100 on the vehicle 10 may be simplified. A manufacturing process of the film 100 for simplifying a process of installing the film 100 on the vehicle 10 will be described later in FIG. 2.

Although the film 100 is described as being attached to the sunroof 11 of the vehicle 10, it is not limited thereto. Although not illustrated, the film 100 may be attached to a plurality of windows (e.g., a front windshield, a rear windshield, a side window) of the vehicle 10 including the sunroof 11. The film 100 may be configured to adjust visibility provided through at least a portion of the plurality of transparent windows by being attached to the at least a portion of the plurality of windows.

According to the above-described embodiment, the film 100 for the vehicle 10 may reduce heat transferred from the outside of the vehicle 10 to the inside of the vehicle 10 through the sunroof 11 by being attached to the sunroof 11. Since the transparency of the film 100 is configured to be changeable, the film 100 may provide various user experiences to a user boarding the vehicle 10.

FIG. 2 is a flowchart illustrating an exemplary film manufacturing process.

The manufacturing process of FIG. 2 may be a manufacturing process for processing a film (e.g., the film 100 of FIG. 1B) into a shape corresponding to the shape of the sunroof 11 before being attached to a vehicle (e.g., the sunroof (e.g., sunroof 11 of FIG. 1A) of the vehicle 10 of FIG. 1A).

In step 201, a film fabric (e.g., the film fabric 300 of FIG. 3) may be prepared to be processed into a film 100 having a shape corresponding to the shape of the sunroof 11 of the vehicle 10. For example, the film fabric 300 may be provided in a structure in which a plurality of layers is laminated, as illustrated in FIG. 3. For example, the film fabric 300 prepared in step 201 may include a layer including a material with relatively high heat resistance for thermal forming in step 203.

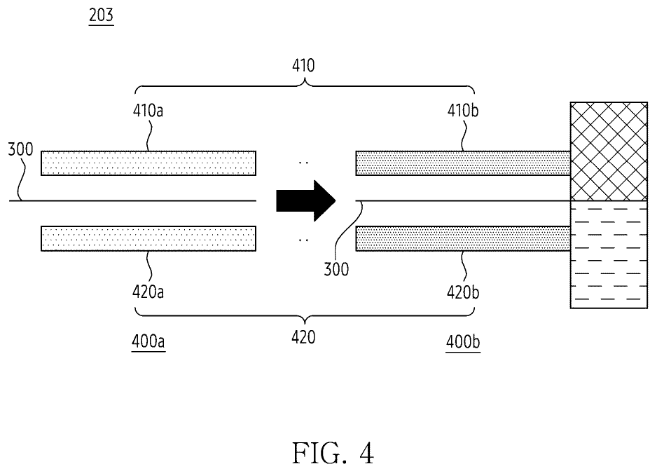

In step 203, the film fabric 300 may be heated. The film fabric 300 may be easily deformed by heating. For example, the film fabric 300 may be heated by a heater (e.g., the first heater 410 and the second heater 420 of FIG. 4). For example, step 203 may include moving the film fabric 300 between the first heater 410 and the second heater 420 at a specified speed. A time during which the film fabric 300 is disposed between the first heater 410 and the second heater 420 may be within a range of 10 seconds to 20 seconds, but is not limited thereto. For example, step 203 may include preheating the film fabric 300 within a specified temperature range to reduce the deformation of the film fabric 300 by heating. The step 203 may include heating the film fabric 300 within a temperature range higher than the specified temperature range after preheating the film fabric 300.

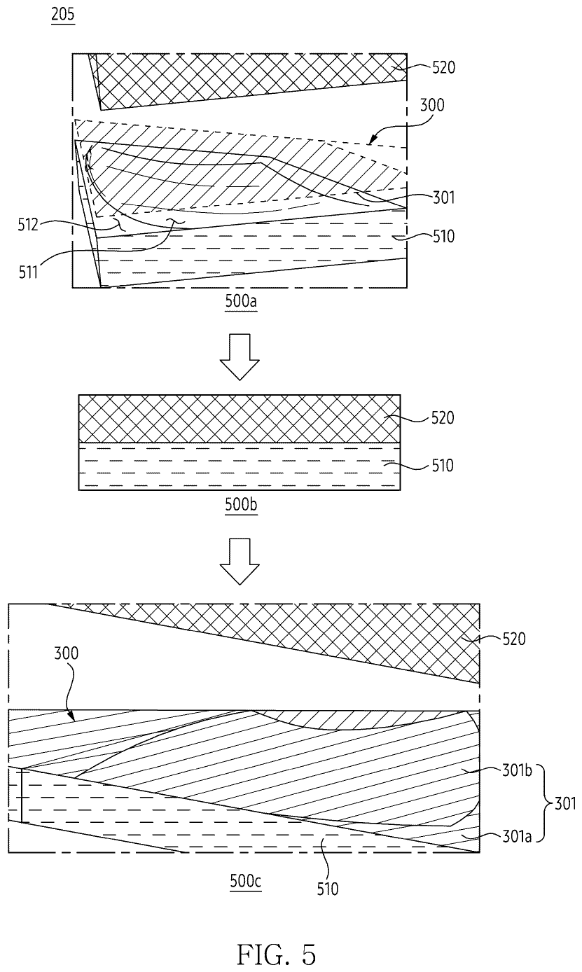

In step 205, the heated film fabric 300 may be vacuum formed. The film fabric 300 can be formed into a shape corresponding to the shape of the sunroof 11 of the vehicle 10 by being vacuum formed. For example, at least a portion of the film fabric 300 may be formed to have a curved surface corresponding to the curved surface of the sunroof 11 through a curved surface (e.g., the curved surface 511 of FIG. 5) within a mold (e.g., the mold 510 of FIG. 5). For example, at least a portion of the film fabric 300 may be pressed to the mold 510 by a press (e.g., the press 520 of FIG. 5). As air between the mold 510 and the press 520 flows out of the mold 510 after at least a portion of the film fabric 300 is interposed between the mold 510 and the press 520 by the press 520, the at least a portion of the film fabric 300 may be pressed to the curved surface 511 within the mold 510. Since the at least a portion of the film fabric 300 is pressed to the curved surface 511 of the mold 510 after being heated in step 203, it may be deformed into a shape corresponding to the shape of the curved surface 511.

In step 207, the vacuum formed film fabric 300 may be cut. At least a portion of the film fabric 300 may be cut to a size substantially the same as or similar to a size of the sunroof 11 of the vehicle 10 by being cut. For example, in step 205, a processing region (e.g., the processing region 301 of FIG. 5) of the film fabric 300 may be pressed to the mold 510 by the press 520. The processing region 301 may be cut from the film fabric 300 in step 207, after being vacuum formed in step 205. According to an embodiment, the step 207 may include a step of separating a second portion (e.g., the second portion 301b of FIG. 5) of the processing region 301 having a curvature corresponding to the shape of the sunroof 11 of the vehicle 10 from a first portion (e.g., the first portion 301a of FIG. 5) surrounding the second portion, after cutting the processing region 301 from the film fabric 300. For example, the processing region 301 may be separated from the film fabric 300 in the step 207. The second portion 301b of the processing region 301 may be cut from the first portion 301a after the processing region 301 is separated from the film fabric 300. The second portion 301b may form a film 100 having a shape corresponding to the shape of the sunroof 11 by being separated from the first portion 301a. The second portion 301b may form a film 100 having a size substantially the same as the size of the sunroof 11 by being separated from the first portion 301a.

According to an embodiment, the step 207 may include a step of cutting the film fabric 300 including a portion having a curvature after vacuum forming into a size within a range of 0.5 m² to 2 m². For example, a length of the processing region 301 cut from the film fabric 300 may be within a range of 1,000 mm to 2,000 mm. A width of the processing region 301 may be within a range of 700 mm to 1,500 mm. However, it is not limited thereto. For example, through the step 205, the processing region 301 may include a first portion 301a that is substantially flat, and a second portion 301b that has a curvature due to the curved surface 511 of the mold 510. The processing region 301 including the first portion 301a and the second portion 301b may be cut from the film fabric 300 to have a size within a range of 0.5 m² to 2 m².

In step 209, an electrode layer (e.g., the first electrode layer 341, the second electrode layer 342 of FIG. 3) in the cut film fabric 300 may be connected to a wire (e.g., the wire 610 of FIG. 6). For example, the film fabric 300 may include a liquid crystal layer (e.g., the liquid crystal layer 310 of FIG. 3), at least one conductive polymer layer (e.g., at least one conductive polymer layer 320 of FIG. 3) laminated to the liquid crystal layer 310, and at least one electrode layer (e.g., at least one electrode layer 340 of FIG. 3) disposed on the at least one conductive polymer layer 320. The at least one conductive polymer layer 320 and the at least one electrode layer 340 may be electrically connected to the wire 610 in step 209. For example, the at least one conductive polymer layer 320 and the at least one electrode layer 340 in the second portion 301b separated from the first portion 301a in step 207 may be connected to the wire 610 in step 209. The film 100 may be easily installed in the vehicle 10 by being provided in a structure connected to the wire 610.

According to the above-described embodiment, a manufacturing process of the film 100 may provide the film 100 in a shape corresponding to the shape of the sunroof 11 of the vehicle 10. The manufacturing process may provide the film 100 in a size corresponding to the size of the sunroof 11. The manufacturing process may include a step of connecting the film 100 to the wire 610, thereby providing the film 100 with a structure capable of being easily installed on the vehicle 10.

FIG. 3 is a cross-sectional view of an exemplary film.

Referring to FIG. 3, a film 100 may include a liquid crystal layer 310, at least one conductive polymer layer 320, at least one substrate layer 330, at least one electrode layer 340, and at least one coating layer 350. The film fabric 300 to be processed into the film 100 may have a structure substantially identical to a structure in which a plurality of layers within the film 100 are laminated.

According to an embodiment, the liquid crystal layer 310 may include a plurality of liquid crystal molecules 315. For example, the liquid crystal layer 310 may have a form in which the plurality of liquid crystal molecules 315 are dispersed within a conductive polymer material. Due to the conductive polymer material, the liquid crystal layer 310 may have conductivity. For example, the plurality of liquid crystal molecules 315 in the liquid crystal layer 310 may be dispersed irregularly within the liquid crystal layer 310 while no current is flowing in the liquid crystal layer 310. As the plurality of irregularly dispersed liquid crystal molecules 315 scatter light incident on the liquid crystal layer 310, the film 100 may be configured to be opaque. For example, at least a portion of the plurality of liquid crystal molecules 315 in the liquid crystal layer 310 may be aligned by having a designated direction while current is flowing in the liquid crystal layer 310. According to the intensity of the current flowing in the liquid crystal layer 310, the number of the plurality of liquid crystal molecules 315 aligned in the designated direction may be changed. Since at least a portion of the light incident on the liquid crystal layer 310 is transmitted by at least a portion of the plurality of liquid crystal molecules 315 aligned while the current is flowing in the liquid crystal layer 310, the film 100 may be configured to be substantially transparent or translucent. Since the number of the plurality of liquid crystal molecules 315 aligned according to the intensity of the current varies, the film 100 may be configured so that the transparency of the film 100 is controlled according to the intensity of the current flowing in the liquid crystal layer 310.

According to an embodiment, at least one conductive polymer layer 320 may be laminated to the liquid crystal layer 310. For example, the at least one conductive polymer layer 320 may include a first conductive polymer layer 321 and a second conductive polymer layer 322. The first conductive polymer layer 321 may be laminated on a first surface 311 of the liquid crystal layer 310. The second conductive polymer layer 322 may be laminated on a second surface 312 of the liquid crystal layer 310 opposite to the first surface 311. For example, at least one conductive polymer layer 320 may cover at least a portion of the liquid crystal layer 310. For example, at least one conductive polymer layer 320 may be in contact with the liquid crystal layer 310. For example, at least one polymer layer 320 may be electrically connected to a wire (e.g., the wire 610 of FIG. 6). As power is supplied to the at least one conductive polymer layer 320 through the wire 610, current may flow through the at least one conductive polymer layer 320 and the liquid crystal layer 310 in contact with the at least one conductive polymer layer 320.

For example, at least one conductive polymer layer 320 may include a relatively heat-resistant material. The at least one conductive polymer layer 320 may have flexibility. The at least one conductive polymer layer 320 may include plastic, but is not limited thereto. The film fabric 300 may reduce damage to the film fabric 300 due to heating in the step 203 of FIG. 2 by including the at least one conductive polymer layer 320 having relatively high heat resistance. The film fabric 300 may be configured to be easily deformable in the step 205 of FIG. 2 by including the conductive polymer layer 320 having flexibility.

According to an embodiment, at least one substrate layer 330 may be disposed on the at least one conductive polymer layer 320. In this document, when an element is described as being “on” another element, it should be understood that the element may be directly on the other element or that intervening elements may be present therebetween. For example, in this document, “B disposed on A” may refer to “B disposed over A”. For example, in this document, “B disposed on A” may refer to “B facing A and spaced apart from A”. For example, “at least one substrate layer 330 disposed on at least one conductive polymer layer 320” may mean “at least one substrate layer 330 in contact with at least one conductive polymer layer 320”. For example, “at least one substrate layer 330 disposed on at least one conductive polymer layer 320” may mean “at least one substrate layer 330 facing and spaced apart from at least one conductive polymer layer 320”.

For example, at least one substrate layer 330 may include a first substrate layer 331 and a second substrate layer 332. The first substrate layer 331 may be disposed on the first conductive polymer layer 321. The second substrate layer 332 may be disposed on the second conductive polymer layer 322. For example, at least one substrate layer 330 may form an outer appearance of the film 100 and/or film fabric 300. For example, at least one substrate layer 330 may include at least one of Poly Ethylene Terephthlate (PET), Polycarbonate (PC), Polyethylene Napthalene (PEN), Polyurethane (PU), and Polyimide (PI), but it is not limited thereto.

For example, the first conductive polymer layer 321 may be disposed between the first substrate layer 331 and the liquid crystal layer 310. The second conductive polymer layer 322 may be disposed between the second substrate layer 332 and the liquid crystal layer 310. For example, the first substrate layer 331 may be spaced apart from the first conductive polymer layer 321. A plurality of layers may be interposed between the first substrate layer 331 and the first conductive polymer layer 321. The second substrate layer 332 may be spaced apart from the second conductive polymer layer 322. A plurality of other layers may be interposed between the second substrate layer 332 and the second conductive polymer layer 322.

According to an embodiment, at least one electrode layer 340 may be disposed between at least one conductive polymer layer 320 and at least one substrate layer 330. For example, at least one electrode layer 340 may include a first electrode layer 341 and a second electrode layer 342. The first electrode layer 341 may be disposed between the first conductive polymer layer 321 and the first substrate layer 331. The second electrode layer 342 may be disposed between the second conductive polymer layer 322 and the second substrate layer 332. For example, the first electrode layer 341 may be disposed on a first surface 311 of the liquid crystal layer 310. The second electrode layer 342 may be disposed on a second surface 312 opposite to the first surface 311 of the liquid crystal layer 310.

For example, at least one electrode layer 340 may be electrically connected to a wire 610. By receiving power through the wire 610, the at least one electrode layer 340 may be configured such that current flows through the liquid crystal layer 310 together with the at least one conductive polymer layer 320. For example, the at least one electrode layer 340 may include a material having relatively high rigidity. The at least one electrode layer 340 may include metal, but is not limited thereto. For example, the at least one electrode layer 340 may be at least partially oxidized by being heated by heat transferred from the liquid crystal layer 310 and/or the at least one conductive polymer layer 320. The at least one electrode layer 340 may be discolored or damaged by being oxidized. The film 100 and/or the film fabric 300 may be required to have a structure to reduce oxidation of the at least one electrode layer 340.

According to an embodiment, the film 100 may include at least one coating layer 350 interposed between at least one conductive polymer layer 320 and at least one electrode layer 340. For example, the at least one coating layer 350 may include a first coating layer 351 and a second coating layer 352. The first coating layer 351 may be interposed between the first conductive polymer layer 321 and the first electrode layer 341. The second coating layer 352 may be interposed between the second conductive polymer layer 322 and the second electrode layer 342. For example, the first coating layer 351 may be coated on one surface of the first electrode layer 341 facing the liquid crystal layer 310. The second coating layer 352 may be coated on one surface of the second electrode layer 342 facing the liquid crystal layer 310.

For example, at least one coating layer 350 may separate the liquid crystal layer 310 and/or at least one conductive polymer layer 320 from at least one electrode layer 340. The at least one coating layer 350 may include a material having relatively low thermal conductivity. The at least one coating layer 350 may include urethane, but it is not limited thereto. For example, as current flows through the liquid crystal layer 310 and/or the at least one conductive polymer layer 320, heat may be emitted from the liquid crystal layer 310 and/or the at least one conductive polymer layer 320. The film 100 may reduce heat transferred from the liquid crystal layer 310 and/or the at least one conductive polymer layer 320 to the at least one electrode layer 340, by including at least one coating layer 350 interposed between the at least one conductive polymer layer 320 and the at least one electrode layer 340. The at least one coating layer 350 may reduce damage to the at least one electrode layer 340 due to the heat, by insulating the heat from the liquid crystal layer 310 and/or the at least one conductive polymer layer 320 to the at least one electrode layer 340.

According to an embodiment, the film 100 and/or the film fabric 300 may have a heat deflection temperature within a range being greater than or equal to 350 degrees and being less than or equal to 500 degrees. For example, the film 100 and/or the film fabric 300 may have a heat deflection temperature within a range being greater than or equal to 350 and being less than or equal to 500 degrees, by including the first conductive polymer layer 321 and the second conductive polymer layer 322 having relatively high heat resistance. For example, the film 100 and/or the film fabric 300 may have a heat deflection temperature within a range being greater than or equal to 350 degrees and being less than or equal to 500 degrees, by including the first coating layer 351 and the second coating layer 352 having relatively low thermal conductivity. For example, the film 100 and/or the film fabric 300 may include at least one conductive polymer layer 320, at least one electrode layer 340, and at least one coating layer 350, instead of Indium Tin Oxide (ITO) to be laminated on the liquid crystal layer 310, thereby increasing heat resistance. However, it is not limited thereto. The film fabric 300 may have a heat deflection temperature within a range being greater than or equal to 350 degrees and being less than or equal to 500 degrees, thereby reducing the film fabric 300 from being damaged by heating in step 203 of FIG. 2. The film 100 may increase a heat blocking rate of heat introduced through the sunroof 11 of the film 100 while being attached to the sunroof 11 of the vehicle (e.g., the vehicle 10 of FIG. 1A), by including at least one coating layer 350 and at least one conductive polymer layer 320.

According to the above-described embodiment, the film 100 may increase the heat resistance of the film 100 by including at least one conductive polymer layer 320. The film 100 may reduce damage to at least one electrode layer 340 due to heat emitted from the liquid crystal layer 310 and the at least one polymer layer 320, by including at least one coating layer 350.

FIG. 4 illustrates a heating process of an exemplary film.

The heating process of FIG. 4 may be referred to as step 203 of FIG. 2.

In step 400a, the film fabric 300 prepared in step 201 of FIG. 2 may be heated to a temperature within a first reference range. For example, the step 400a may be a step of preheating the film fabric 300. For example, in the step 400a, the film fabric 300 may move between a first heater 410 and a second heater 420. For example, the film fabric 300 may pass between the first heater 410 and the second heater 420 at a specified speed. For example, in the step 400a, the film fabric 300 may pass between a first region 410a of the first heater 410 and a second region 420a of the second heater 420. The first region 410a and the second region 420a may heat the film fabric 300 to a temperature within the first reference range. The temperature in the first reference range may be located within a range being greater than or equal to 1 degree and being less than or equal to 100 degrees, but is not limited thereto.

In step 400b, the film fabric 300 heated to a temperature within the first reference range may be heated to a temperature within a second reference range higher than the temperature within the first reference range before being vacuum formed in step 205 of FIG. 2. For example, in the step 400b, after being heated by the first region 410a and the second region 420a, the film fabric 300 may be moved to be located between a third region 410b of the first heater 410 extending from the first region 410a and a fourth region 420b of the second heater 420 extending from the second region 420a. The third region 410b and the fourth region 420b may heat the film fabric 300 to a temperature within a second reference range higher than a temperature within the first reference range. The temperature within the second reference range may be located within a range being greater than or equal to 100 degrees and being less than or equal to 350 degrees, but is not limited thereto. The film fabric 300 may be easily deformed by being heated to a temperature within the second reference range in the step 400b.

According to the above-described embodiment, a process of heating the film fabric 300 may reduce damage to the film fabric 300, by including a step of heating the film fabric 300 to a temperature within the first reference range. The process of heating the film fabric 300 may provide a state in which the film fabric 300 is easily formed in the step 205, by including a step of heating to a temperature within the second reference range higher than the temperature within the first reference range.

FIG. 5 illustrates a vacuum forming process of an exemplary film.

The vacuum forming process of FIG. 5 may be referred to as step 205 of FIG. 2.

In step 500a, the film fabric 300 heated in the step 203 of FIG. 2 may be located between a mold 510 in which the curved surface 511 is formed and a press 520 facing the mold 510. For example, in the step 500a, a processing region 301 of the film fabric 300 may be located on a curved surface 511 of the mold 510 having a shape corresponding to a sunroof (e.g., the sunroof 11 of FIG. 1A) of a vehicle (e.g., the vehicle 10 of FIG. 1A) and a support surface 512 surrounding the curved surface 511. The processing region 301 may include the curved surface 511 and the support surface 512 and have a size corresponding to the size of one surface of the mold 510 facing the press 520.

In step 500b, the film fabric 300 may be pressed to the mold 510 by being pressed by the press 520. A space between the mold 510 and the press 520 may be sealed by the press 520. For example, the press 520 may seal a space formed between the processing region 301 and the mold 510 by the curved surface 511 of the mold 510, by pressing the processing region 301 on the mold 510 toward the mold 510. According to an embodiment, in the step 500b, air inside the space between the mold 510 and the press 520 may be removed. As the air between the mold 510 and the press 520 is removed, the film fabric 300 between the mold 510 and the press 520 may be pressed to the curved surface 511 of the mold 510. For example, the processing region 301 of the film fabric 300 may be pressed to a support surface 512 of the mold 510 by the press 520. As air between the processing region 301 and the curved surface 511 of the mold 510 is removed in the step 500b, at least a portion of the processing region 301 may be pressed to the curved surface 511. As the processing region 301 is heated in the step 203, it may be deformed into a shape corresponding to the shape of the curved surface 511 by being pressed to the curved surface 511.

In step 500c, the pressing by the press 520 applied to the film fabric 300 may be released. The processing region 301 of the film fabric 300 may include a first portion 301a pressed to the support surface 512 of the mold 510 and a second portion 301b pressed to the curved surface 511 of the mold 510. The second portion 301b may have a shape corresponding to the sunroof 11 of the vehicle 10 by being pressed to the curved surface 511. The processing region 301 including the first portion 301a and the second portion 301b may be moved by passing between the mold 510 and the press 520 to be cut from the film fabric 300.

According to the above-described embodiment, a process of vacuum forming the film fabric 300 may form at least a portion (e.g., the processing region 301) of the film fabric 300 into a shape corresponding to the shape of the sunroof 11 of the vehicle 10, by including a step of pressing the film fabric 300 to the mold 510 in which the curved surface 511 is formed.

FIG. 6 illustrates an exemplary film to which a wire is connected.

Referring to FIG. 6, a film 100 may be connected to a wire 610. For example, the film 100 may be referred to in a form in which the processing region 301 of FIG. 5 and/or the second portion 301b having a curvature in the processing region 301 is separated from the film fabric 300. For example, the wire 610 may be electrically connected to at least a portion of a plurality of layers in the film 100. For example, referring to FIG. 3 together, one end of the wire 610 may be connected to at least one conductive polymer layer 320 and at least one electrode layer 340 of the film 100. The film 100 may be provided in a structure capable of being easily installed in a vehicle (e.g., the vehicle 10 of FIG. 1A) by being provided in a form connected to the wire 610.

According to an embodiment, the film 100 may have a size S of 0.5 m² to 2 m². A length of the film 100 may be within a range being greater than or equal to 1,000 nim and being less than or equal to 2,000 mm. A width of the film 100 may be within a range being greater than or equal to 700 mm and being less than or equal to 1,500 mm. However, it is not limited thereto. For example, the film 100 may be cut to have a size S between 0.5 m² to 2 m2 from the film fabric 300 through the step 207 of FIG. 2. The film 100 may be provided to be easily attached to a sunroof (e.g., the sunroof 11 of FIG. 1A) of the vehicle 10, by having a size S between 0.5 m² to 2 m².

According to the above-described embodiment, the film 100 may be provided in a structure capable of being easily installed in the vehicle 10 by being provided in a structure connected to the wire 610. The film 100 may be provided to be easily attached to the sunroof 11 of the vehicle 10 by having a size S within a specified range.

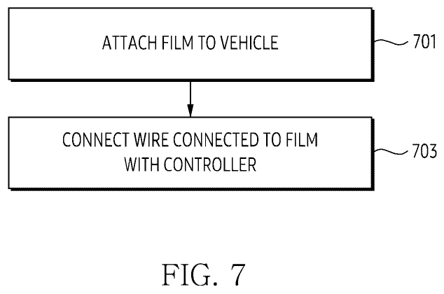

FIG. 7 is a flowchart illustrating a process for installing an exemplary film in a vehicle.

Referring to FIG. 7, in step 701, a film (e.g., the film 100 of FIG. 1B) provided through the process of FIG. 2 may be attached to a vehicle (e.g., the vehicle 10 of FIG. 1A). For example, the film 100 may be attached to an inner surface (e.g., the inner surface 11b of FIG. LA) that faces the inside of the vehicle 10 among the sunroof (e.g., the sunroof 11 of FIG. 1A) of the vehicle 10. Since the film 100 has a curvature to have a shape corresponding to the shape of the sunroof 11, it may be easily attached to the sunroof 11. Since the film 100 has a size corresponding to the size of the sunroof 11, it may be easily attached to the sunroof 11.

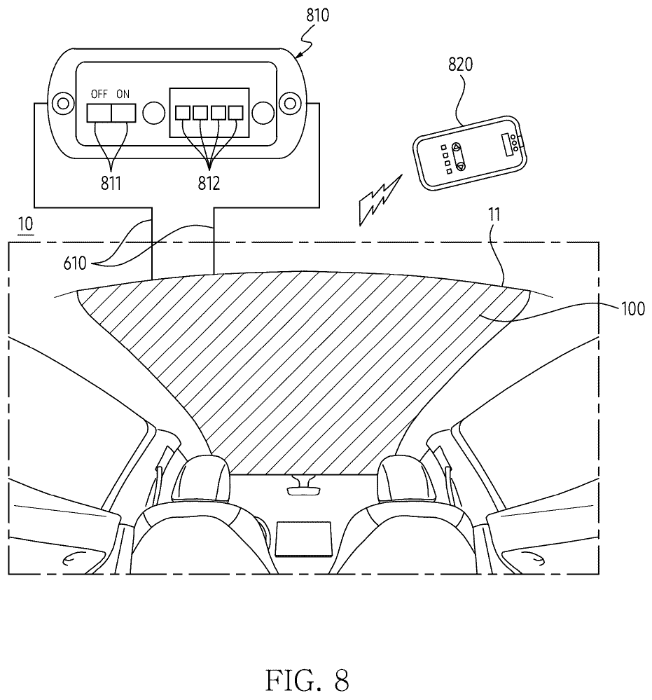

In step 703, a wire (e.g., the wire 610 of FIG. 6) connected to the film 100 may be connected to a controller (e.g., the first controller 810 of FIG. 8). For example, an end of the wire 610 may be electrically connected to at least one conductive polymer layer (e.g., the at least one conductive polymer layer 320 of FIG. 3) and at least one electrode layer (e.g., the at least one electrode layer 340 of FIG. 3) in the film 100. Another end of the wire 610 opposite to the end may be connected to the controller. The controller may apply power to the film 100 through the wire. The controller may be configured to control the intensity of current flowing in the film 100, thereby adjusting the transparency of the film 100.

According to the above-described embodiment, the film 100 may be provided in a structure connected to the wire 610, thereby being provided in a structure capable of being easily installed with a controller. The film 100 may be provided to have a shape corresponding to the sunroof 11 of the vehicle 10, thereby being easily attached to the sunroof 11.

FIG. 8 illustrates an internal structure of a vehicle to which an exemplary film is attached.

Referring to FIG. 8, the film 100 may be attached to the sunroof 11 of the vehicle 10. The film 100 may be connected to a first controller 810 through the wire 610. The first controller 810 may be configured to apply power to the film 100 through the wire 610. For example, the first controller 810 may include a power button 811 and an adjustment button 812. The first controller 810 may apply power to the film 100 or block applying the power to the film 100, through the power button 811. The first controller 810 may be configured to adjust the transparency of the film 100 by changing the intensity of current flowing through the film 100 while power is applied to the film 100 through the adjustment button 812.

According to an embodiment, the first controller 810 may be controlled by a second controller 820. For example, the second controller 820 may be configured to control the first controller 810 through wireless communication. The second controller 820 may be configured to apply power to the film 100 or adjust the transparency of the film 100, by controlling the first controller 810.

According to the above-described embodiment, the film 100 may be provided in a structure capable of being easily installed with the controller by being provided in a structure connected to the wire 610. The film 100 may be easily attached to the sunroof 11 by being provided to have a shape corresponding to the sunroof 11 of the vehicle 10.

As described above, a film (e.g., the film 100 of FIG. 1B) for a vehicle may comprise a liquid crystal layer (e.g., the liquid crystal layer 310 of FIG. 3), a first conductive polymer layer (e.g., the first conductive polymer layer 321 of FIG. 3) laminated on a first surface (e.g., the first surface 311 of FIG. 3) of the liquid crystal layer, a second conductive polymer layer (e.g., the second conductive polymer layer 322 of FIG. 3) laminated on a second surface (e.g., the second surface 312 of FIG. 3) opposite to the first surface of the liquid crystal layer, a first substrate layer (e.g., the first substrate layer 331 of FIG. 3) on the first conductive polymer layer, a second substrate layer (e.g., the second substrate layer 332 of FIG. 3) on the second conductive polymer layer, a first electrode layer (e.g., the first electrode layer 341 of FIG. 3) between the first conductive polymer layer and the first substrate layer, and a second electrode layer (e.g., the second electrode layer 342 of FIG. 3) between the second conductive polymer layer and the second substrate layer. The film may have a curvature by being at least partially bent.

According to an embodiment, the film may further comprise a first coating layer (e.g., the first coating layer 351 of FIG. 3) interposed between the first conductive polymer layer and the first electrode layer, and a second coating layer (e.g., the second coating layer 352 of FIG. 3) interposed between the second conductive polymer layer and the second electrode layer. Each of the first coating layer and the second coating layer may include urethane.

According to an embodiment the film, each of the first conductive polymer layer and the second conductive polymer layer may include plastic. Each of the first electrode layer and the second electrode layer may include metal.

According to an embodiment, the film may have a heat deflection temperature within a range being greater than or equal to 350 degrees and being less than or equal to 500 degrees.

According to an embodiment, the film may have a size (e.g., S in FIG. 6) between 0.5 m² and 2 m².

According to an embodiment, a manufacturing method of a film for a vehicle may comprise preparing a film fabric, heating the prepared film fabric, vacuum forming the heated film fabric, and cutting the vacuum formed film fabric.

According to an embodiment, the heating the prepared film fabric may comprise heating the prepared film fabric in a temperature within a first reference range. The heating the prepared film fabric may comprise, after heating the film fabric in the temperature within the first reference range, before vacuum forming the film fabric, heating the film fabric in a temperature within a second reference range higher than the temperature within the first reference range.

According to an embodiment, the vacuum forming the heated film fabric may comprise positioning the heated film fabric between a mold where a curved surface is formed and a press facing the mold. The vacuum forming the heated film fabric may comprise sealing a space between the mold and the press by pressing the film fabric with the press. The vacuum forming the heated film fabric may comprise removing air inside the sealed space so that the film fabric is pressed to the curved surface.

According to an embodiment, the cutting the vacuum formed film fabric may comprise cutting the film fabric including portion having a curvature after the vacuum forming as a size within a range between 0.5 m² and 2 m²

According to an embodiment, the film fabric may comprise a liquid crystal layer, at least one conductive polymer layer laminated on the liquid crystal layer, and at least one electrode layer disposed on the at least one conductive polymer layer. The method may further comprise connecting a wire to the at least one conductive polymer layer and the at least one electrode layer.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

According to various embodiments, each component of the above-described components may include a single entity or multiple entities, and some of the multiple entities may be separately disposed in different components. According to various embodiments, one or more of the above-described components may be omitted, or one or more other components may be added. Alternatively or additionally, a plurality of components may be integrated into a single component. In such a case, the integrated component may still perform one or more functions of each of the plurality of components in the same or similar manner as they are performed by a corresponding one of the plurality of components before the integration. According to various embodiments, processes for manufacturing a film may be performed sequentially, in parallel, or repeatedly, and one or more of the processes may be executed in a different order, omitted, or one or more additional processes may be added.

1. A film for a vehicle comprising:
a liquid crystal layer;
a first conductive polymer layer laminated on a first surface of the liquid crystal layer;
a second conductive polymer layer laminated on a second surface opposite to the first surface of the liquid crystal layer;
a first substrate layer on the first conductive polymer layer;
a second substrate layer on the second conductive polymer layer;
a first electrode layer between the first conductive polymer layer and the first substrate layer; and
a second electrode layer between the second conductive polymer layer and the second substrate layer,
wherein the film has a curvature by being at least partially bent.

2. The film of claim 1, further comprising:
a first coating layer interposed between the first conductive polymer layer and the first electrode layer; and
a second coating layer interposed between the second conductive polymer layer and the second electrode layer,
wherein each of the first coating layer and the second coating layer includes urethane.

3. The film of claim 1,
wherein each of the first conductive polymer layer and the second conductive polymer layer includes plastic,
wherein each of the first electrode layer and the second electrode layer includes metal.

4. The film of claim 1,
wherein the film has a heat deflection temperature within a range being greater than or equal to 350 degrees and being less than or equal to 500 degrees.

5. The film of claim 1.
wherein the film has a size between 0.5 m² and 2m².

6. A manufacturing method of a film for a vehicle comprising:
preparing a film fabric;
heating the prepared film fabric;
vacuum forming the heated film fabric; and
cutting the vacuum formed film fabric.

7. The method of claim 6,
wherein the heating the prepared film fabric comprising:
heating the prepared film fabric in a temperature within a first reference range; and
after heating the film fabric in the temperature within the first reference range, before vacuum forming the film fabric, heating the film fabric in a temperature within a second reference range higher than the temperature within the first reference range.

8. The method of claim 6,
wherein the vacuum forming the heated film fabric comprising:
positioning the heated film fabric between a mold where a curved surface is formed and a press facing the mold;
sealing a space between the mold and the press by pressing the film fabric with the press; and
removing air inside the sealed space so that the film fabric is pressed to the curved surface.

9. The method of claim 6,
wherein the cutting the vacuum formed film fabric comprising:
cutting the film fabric including portion having a curvature after the vacuum forming as a size within a range between 0.5 m² and 2 m².

10. The method of claim 6,
wherein the film fabric comprises:
a liquid crystal layer;
at least one conductive polymer layer laminated on the liquid crystal layer; and
at least one electrode layer disposed on the at least one conductive polymer layer, wherein the method further comprises:
connecting a wire to the at least one conductive polymer layer and the at least one electrode layer.
